(19) United States
(12) Patent Application Publication
(10) Pub. No.: US 2008/0298066 A1
(43) Pub. Date: Dec. 4, 2008

(54) Lamp Unit

(75) Inventors: Patrick Cyriel Van De Voorde, Turnhout (BE); Sergei Shulepov, Eindhoven (NL); Peter Hermanus Bouma, Eindhoven (NL); Hendrik Jan Eggink, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,838

(22) PCT Filed: Apr. 11, 2005
(86) PCT No.: PCT/IB2005/051188

§ 371 Date: Aug. 22, 2008

(30) Foreign Application Priority Data
Apr. 15, 2004 (EP) 04101553.8

(51) Int. Cl. F21V 7/20; F21V 29/02; F21V 7/00

(52) U.S. Cl. 362/264; 362/294; 362/310

(57) ABSTRACT

The present invention relates to a lamp unit, especially to a UHP lamp unit, comprising a housing, a lamp positioned within said housing, a reflector assigned to said lamp for reflecting light emitted by said lamp through a transmission window, and at least one thermal bridge and/or heat sink unit being assigned to the reflector and/or to the lamp and/or to the housing. The or each thermal bridge and/or heat sink unit is preferably made from a material having a good thermal conductivity, e.g. the or each thermal bridge and/or heat sink is made from metal or ceramics.

### FIELD OF THE INVENTION

The present invention is related to a lamp unit, especially to an Ultra High Pressure (UHP) lamp unit used in projection systems like beamers.

### BACKGROUND AND PRIOR ART

Ultra High Pressure (UHP) lamps used in projection systems known from prior art comprise a housing, a lamp positioned within the housing, a reflector assigned to said lamp for reflecting light emitted by said lamp through a transmission window. The lamp is typically designed as a gas discharge lamp, whereby the gas discharge lamp is positioned within an air-tight housing in order to prevent that toxic vapor can dissipate into the surroundings after explosion of the gas discharge lamp. Such a lamp unit is known from the prior art document EP 1 164 328 A2.

The phrase “air-tight” should be understood in a way that the lamp is not in open connection with the surroundings, namely the outside air. This is achieved by seals. However, it should be understood that these seals are usually designed only for lower internal pressures.

A possible reason why the gas discharge lamp of such an UHP lamp unit could explode are high temperatures inside the lamp unit which decrease the tensile strength of the material from which the gas discharge lamp is made. From EP 1 264 328 A2 it is already known to allow a coolant to flow through the lamp unit for the purpose of directly reducing the temperature increase of the lamp.

### SUMMARY OF THE INVENTION

The present invention provides a lamp unit comprising a housing, a lamp positioned within said housing, a reflector assigned to said lamp for reflecting light emitted by said lamp through a transmission window, and at least one thermal bridge and/or at least one heat sink unit, being assigned to the reflector and/or to the lamp and/or to the housing.

Preferably, the or each thermal bridge and/or heat sink unit is made from a material having a good thermal conductivity, e.g. the or each thermal bridge and/or heat sink unit is made from metal or ceramics.

In accordance with a preferred embodiment of the present invention, at least one thermal bridge is assigned to the reflector and to an inner surface of the housing, whereby the or each thermal bridge is connecting the reflector and the inner surface of the housing.

In accordance with a further preferred embodiment of the present invention, a thermal bridge is assigned to a neck portion and/or a front portion of the lamp and to the transmission window, whereby said thermal bridge is connecting the neck portion and/or the front portion of the lamp to the transmission window.

Additional thermal bridges and/or heat sink units can be assigned to a front portion of the reflector and to the inner surface of the housing, to the transmission window and to the housing, and to the outer surface of the housing.

### BRIEF DESCRIPTION OF THE DRAWINGS

FIG. 1 shows a cross-sectional view through a lamp unit according to the present invention.

### DETAILED DESCRIPTION

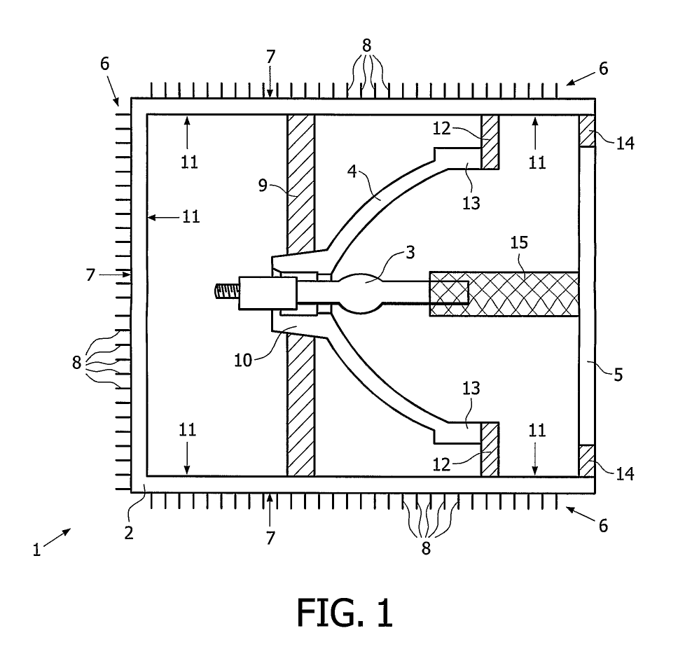

FIG. 1 shows a cross sectional view through a lamp unit 1 according to the present invention. The lamp unit 1 shown in FIG. 1 is designed as a so-called ultra high pressure lamp unit comprising an air-tight housing 2, a gas discharge lamp 3 positioned within said housing 2 and a reflector 4 assigned to the gas discharge lamp 3 for reflecting light emitted by the lamp 3 through a transmission window 5. The housing 2 of the lamp unit can have different shapes like a cylinder or a cone.

In order to reduce a temperature increase of the gas discharge lamp 3 during operation and in order to prevent a reduction of the tensile strength of the material from which the lamp 3 is made, at least one thermal bridge and/or heat sink unit is assigned to the lamp unit 1, namely to the reflector 4 and/or to the lamp 3 and/or to the housing 2.

The or each thermal bridge and/or heat sink unit provide a passive cooling of the critical parts of the UHP lamp unit 1 and are preferably made from a material having a good thermal conductivity like metal or ceramics.

According to FIG. 1, a heat sink unit 6 is assigned to the outer surface 7 of the air tight housing 2, whereby said heat sink unit 7 is provided by cooling fins 8 attached to the outer surface 7 of the air tight housing 2.

Thermal bridges are assigned to the reflector and to an inner surface of the housing, whereby said thermal bridges are connecting the reflector and the inner surface of the housing. A first thermal bridge 9 is assigned to a neck portion 10 of the reflector 4 and to the housing 2, whereby said first thermal bridge 9 is connecting the neck portion 10 of the reflector 4 to an inner surface 11 of the housing 2. A second thermal bridge 12 is assigned to a front portion 13 of the reflector 4 and to the housing 2, whereby said second thermal bridge 12 is connecting the front portion 13 of the reflector 4 to said inner surface 11 of the housing 2.

As shown in FIG. 1, a further thermal bridge 14 is assigned to the housing 2 and to the transmission window 5, whereby said thermal bridge 14 is connecting the transmission window 5 to the housing 2.

According to the embodiment shown in FIG. 1, a further thermal bridge 15 is assigned to a front portion of the gas discharge lamp 3 and to the transmission window 5. Said thermal bridge 15 is connecting the front portion of the lamp 3 to the transmission window 5. Such a thermal bridge 15 connecting the front portion of the gas discharge lamp 3 to the transmission window 5 is preferably used in combination with a parabolic reflector. However, it could also be used in connection with an elliptic reflector.

In the embodiment shown in FIG. 1, the lamp unit 1 comprises in total five independent thermal bridges or heat sink units 6, 9, 12, 14 and 15, whereby these thermal bridges or heat sink units are conducting heat from the critical portions of the lamp unit 1 to the surroundings. The thermal bridges or heat sink units 6, 9, 12, 14 and 15 therefore provide a passive cooling mechanism for the lamp unit 1.

It should be noted, that within alternative embodiments of the present invention the lamp unit could also comprise a subset of the five thermal bridges or heat sink units shown in FIG. 1. Any combination of subsets of the five shown thermal bridges or heat sink units 6, 9, 12, 14 and 15 are possible and within the scope of this invention.

Further on, within the scope of the present invention heat-pipes filled with a coolant like water can be used as thermal bridges. Such coolant-filled heat-pipes provide also a good thermal conductivity and heat transport.

1. Lamp unit, comprising a housing (2), a lamp (3) positioned within said housing (2), a reflector (4) assigned to said lamp (3) for reflecting light emitted by said lamp (3) through a transmission window (5), characterized by at least one thermal bridge (9, 12, 14, 15) and/or at least one heat sink unit (6) being assigned to the reflector (4) and/or to the lamp (3) and/or to the housing (2).

2. Lamp unit according to claim 1, characterized by a heat sink unit (6) assigned to the outer surface (7) of the housing (2).

3. Lamp unit according to claim 2, characterized in that said heat sink unit (6) is provided by cooling fins (8) attached to said outer surface (7) of the housing (2).

4. Lamp unit according to claim 1, characterized by at least one thermal bridge (9, 12) assigned to the reflector (4) and to an inner surface (11) of the housing (2).

5. Lamp unit according to claim 4, characterized by a thermal bridge (9) assigned to a neck portion (10) of the reflector (4) and to an inner surface (11) of the housing (2).

6. Lamp unit according to claim 5, characterized in that said thermal bridge (9) is connecting the neck portion (10) of the reflector (4) and the inner surface (11) of the housing (2).

7. Lamp unit according to claim 1, characterized by a thermal bridge (12) assigned to a front portion (13) of the reflector (4) and to the inner surface (11) of the housing (2).

8. Lamp unit according to claim 7, characterized in that said thermal bridge (12) is connecting the front portion (13) of the reflector (4) to the inner surface (11) of the housing (2).

9. Lamp unit according to claim 1, characterized by a thermal bridge (14) assigned to the transmission window (5) and to the housing (2).

10. Lamp unit according to claim 9, characterized in that said thermal bridge (14) is connecting the transmission window (5) to the housing (2).

11. Lamp unit according to claim 1, characterized by a thermal bridge (15) assigned to a front portion of the lamp (3) and to the transmission window (5).

12. Lamp unit according to claim 11, characterized in that said thermal bridge (15) is connecting the front portion of the lamp (3) to the transmission window (5).
